(19) United States
(12) Patent Application Publication
(10) Pub. No.: US 2004/0134557 A1
(43) Pub. Date: Jul. 15, 2004

(54) Hydrodynamic static mixing apparatus and method for use thereof in transporting, conditioning and separating oil sands and the like

(76) Inventor: Lubomyr M. Cymbalisty, Edmonton (CA)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/736,485

(22) Filed: Dec. 15, 2003

Related U.S. Application Data
(63) Continuation-in-part of application No. 10/361,267, filed on Feb. 10, 2003.
(60) Provisional application No. 60/392,281, filed on Jun. 28, 2002.

(51) Int. Cl. F16L 9/00

(52) U.S. Cl. 138/177; 138/178; 138/39

(57) ABSTRACT

A static hydrodynamic mixer undulating interior conduit provides a static mixing apparatus which utilizes a spiral, coiled or curved conduit to cause dynamic mixing of flowing fluids while they are pumped through the conduit. Gentle but pervasive low-shear mixing is produced by axial and radial secondary currents induced by gravitational and centrifugal body forces acting on the solid and liquid fluid components flowing through the undulating conduit. The vigor of mixing and resistance to flow increases with the undulation's amplitude/pitch ratio. The application includes a method of use in extracting bitumen from oil sands.

### CROSS-REFERENCE TO RELATED PATENT APPLICATIONS

This patent application is a continuation-in-part of co-pending U.S. patent application Ser. No. 10/361,267, filed Feb. 10, 2003, which claims the benefit of U.S. Provisional Patent Application No. 60/392,281, filed Jun. 28, 2002.

### FIELD OF THE INVENTION

This invention pertains to a hydrodynamic mixing conduit apparatus with no moving parts, generally known in the industry as a static mixer. This invention expands the functionality of static mixers by providing for the mixing and transporting of abrasive materials, e.g., sand, gravel, etc., at high concentrations (above 70 wt. %), at reduced velocities, without creating the risk of plugging the conduit, while minimizing the destructive effect of the abrasive materials on the conduit itself.

More particularly, an application of the conduit mixer apparatus is a method of extracting bitumen from oil sands, where the mixer invention, when incorporated into and adapted to existing and modified systems, will give an increase in the quantity of oil recovered and result in an improved quality of the final product, and at a lesser capital cost of equipment and maintenance than is now incurred in the extraction process. Furthermore, it has potential for reducing transportation costs in sand tailings disposal and mine back fill.

This mixer apparatus and method can be adapted to give an effective and improved system of extraction of oil from oil sands deposits of different varieties as they appear in many countries all over the world.

### BACKGROUND OF THE INVENTION

The primary immediate utilization of this mixing conduit invention will be in the extraction of oil from the oil sands such as found in northern Alberta, Canada, and more specifically, in the Fort McMurray area in northeastern Alberta.

There, the mined oil sands are comprised of coarse sand particles coated by a thin film of connate water, with oil filling the interstices (voids/spaces) and minute particles of clay and mineral (fines) distributed within the water sheaths.

Water, chemicals and energy in the form of mixing are added to the oil sand, resulting in formation of slurry.

In the rudimentary stage, the slurry contains considerable amounts of unbroken lumps of oil sand, too large for the next stage of processing. This situation becomes more difficult in winter months, when frozen lumps aggravate the problem. To manage the situation, the mixing equipment has to be robust enough to be able to disintegrate oversize ore, and form homogeneous slurry.

After formation, the oil sand slurry moves through conditioning and dilution-settling stages until the oil is eventually separated from the solids, thus forming the final product froth.

Transporting and processing a slurry containing highly abrasive material inflicts extreme wear on equipment and requires excessive amounts of power to keep the slurry moving at high velocity in order to create turbulence and thereby prevent blockage of the conduit by floating oil or settled solids.

Various methods have been proposed over the years to induce swirl in slurry flow within conduits, for the purpose of mixing the slurry to prevent flow stratification, segregation and settling of suspended solids. One of the earliest proposals was put forward over a century ago, in U.S. Pat. No. 630,605, which introduced the idea of using curved flow-deflecting ribs spaced at intervals along the lower half of the inner wall of a circular pipe, for the purpose of preventing deposits of sediment on the bottom of the pipe. Alternating the angle of curvature of the ribs was recommended to prevent swirling flow.

U.S. Pat. No. 1,451,272 extended the concept to include internal spiral ribs, having single or multiple starts, wrapped around the circumference and running the length of the pipe or spaced at intervals, for the purpose of maintaining dredged solids in suspension. The inventor recommended using three-start spirals with a Pitch/Diameter ratio between 15 and 25.

U.S. Pat. No. 1,662,178 also proposed using spiral ribs to maintain dredged solids in suspension so as to prevent plugging and increase the speed of solids flow while conserving power. The spacing between ribs gradually increased along the pipe so solids would not jam between the ribs.

British Patents No. GB521548 and GB569000 described an adaptation of the idea of helical ribs for the purpose of increasing heat transfer within boiler tubes. This was accomplished by creasing the exterior of cylindrical tubes with three helical creases that wound around the tube circumference with a Pitch/Diameter ratio of about 8. The three helical creases protruded into the tube as helical ribs along its length, which added a swirling action to the fluid flow through the tube and increased the efficiency of heat transfer.

Over the years that followed, many other patents (for example U.S. Pat. No. 4,111,402, No. 4,314,974, No. 4,725,287, No. 4,983,319, No. 5,597,236, No. 6,354,730, and No. 6,467,949) proposed many different shapes of ribs, vanes and deflectors for insertion into cylindrical pipes for the purpose of mixing fluids moving through the pipes. Virtually all the inserted components shared two common features: smooth inclined surfaces to deflect the flow, and sharp edges to shear the flow. As a result, all these designs shared several weaknesses: high flow resistance due to strongly sheared flow over the sharp edges, high rates of insert wear due to edge abrasion by slurry solids, and vulnerability to plugging at high solid loadings.

It is the purpose of the present invention to overcome these disadvantages by means of a novel design of Undulating Conduit Hydrodynamic Mixer whose smooth interior is resistant to plugging and has no sharp edges to cause wake drag and abrasive wear. By virtue of its gentle but robust mixing action of slurries with high solids content, the present invention can also be applied advantageously to the processing of bituminous sands, in particular the digestion (comminution) of oil sand lumps, the liberation of bitumen from the loosened sand grains, the aeration of the liberated bitumen droplets, and the agglomeration of aerated bitumen droplets.

Cross reference is made to Cymerman et al. U.S. Pat. No. 5,264,118 entitled “Pipeline Conditioning Process for Mined Oil-Sand” and the references therein for more detailed background information on the types of equipment and methods applied in the field.

The present invention provides a hydrodynamic mixing conduit that has several advantages over presently known mixing devices and processes, such as follows:

1. It is an effective mixer of materials by virtue of the dynamic intermixing action that it imparts to contents in motion. It is especially effective in mixing solid and liquid matter to form a homogeneous fluid, such as a slurry composed of water, oil and sand;

2. The process maintains uniform distribution of fluid components in motion;

3. By virtue of its smooth interior, the hydrodynamic mixing conduit sustains uniformity of mixing without creating the high shear rates that are especially harmful when mixing oily substances;

4. The process keeps all fluid components in continuous suspension during transport, thereby preventing stratification of components having different densities and properties.

5. The undulating conduit mixes abrasive solids in liquids with relatively low erosion of the conduit, by virtue of the dispersion of the abrasive material over the total cross-section of the conduit, which prevents any concentrated abrasive action such as occurs when densified solids slide along the bottom of a straight pipe;

6. The hydrodynamic mixing conduit is a transportation facility to carry and deliver the contents, in addition to being a mixer;

7. The hydrodynamic mixer can be incorporated into existing transportation systems at intervals to revitalize transported fluids whose consistency deteriorates due to the presence, for example, of floating aerated material or deposited high-density materials such as sand. The process of fluid ‘revitalization’ is here defined to be the combined action of the processes of resuspending, refluidizing and remixing the fluid components to remove stratification and regain uniformity of dispersion; and

8. The primary and secondary flow currents induced by the conduit undulations will effectively revitalize fluids in both laminar and turbulent flows.

These and other advantages of the invention, as well as additional inventive features, will be apparent from the description of the invention provided herein.

### BRIEF SUMMARY OF THE INVENTION

The invention is an undulating conduit hydrodynamic mixer which is a static hydrodynamic mixing apparatus utilizing a spiral, coiled, curved or serpentine conduit that causes dynamic mixing of its flowing contents by virtue of the primary and secondary flow patterns created when the contents are pumped through the undulations of the static conduit.

In one of its important applications, the undulating conduit hydrodynamic mixer can be interposed at various stages of processing and transportation of oil-laden slurries in oil sands extraction systems.

### BRIEF DESCRIPTION OF THE DRAWINGS

FIG. 1 is an illustrative side sectional view of a length of undulating conduit in accordance with the present invention for the case where undulations are in the vertical direction only.

FIG. 2 is an end diagrammatic view of the conduit of FIG. 1 showing the effect of adding horizontal undulations to the vertical undulations; FIG. 2 includes definitions and equations for the various radii shown.

FIG. 3 is an illustrative side sectional view of an alternative length of vertically undulating conduit having a more gentle undulation (lower amplitude, longer pitch) than that shown in FIG. 1;

FIG. 4a is an end view of a length of helically undulating conduit having a circular cross-section and an open center channel;

FIG. 4b is a shallow perspective side view of the helically undulating conduit of FIG. 4a;

FIG. 4c is a steep perspective side view of the helically undulating conduit of FIG. 4a;

FIG. 5 is an illustrative representation of the end views of several alternative cross-sectional shapes for undulating conduits;

FIG. 6a is an illustrative side view of an alternative form of undulating conduit mixer in which the pitch of the helical undulation is non-zero and the radius of the helical undulation is zero, for the case where the undulating conduit has an oval cross-section and the direction of rotating undulation is abruptly reversed to provide a short region of intense mixing in the conduit.

FIG. 6b is a magnified end view of the conduit in FIG. 6a, showing the open central channel provided by a spiral-twisted undulating conduit having an oval cross-section.

FIG. 6c is an illustrative trimetric view of a short section of the conduit of FIG. 6b inserted as a flow revitalizer between two sections of standard cylindrical pipe.

FIG. 7 is a flow diagram of an oil sands bitumen extraction method utilizing undulating conduits of the present invention.

### DETAILED DESCRIPTION OF THE INVENTION

The following descriptions are of the static undulating conduit hydrodynamic mixer (the “apparatus”) and the processes involved in the application of the invention.

The Undulating Conduit Hydrodynamic Mixer—The undulating conduit hydrodynamic mixer is the physical plant that provides controlled continuous positive dynamic interaction within the transported slurry. The undulating conduit creates the optimum environment for mixing of the oil sands slurry. The action may be described as directional flow changes, accelerating and decelerating, twirling, spiraling, gyrating, folding the slurry over on itself and stretching the mixture as it is transported.

The above pattern of dynamic flow provides several advantages usually not available in present mixing systems.

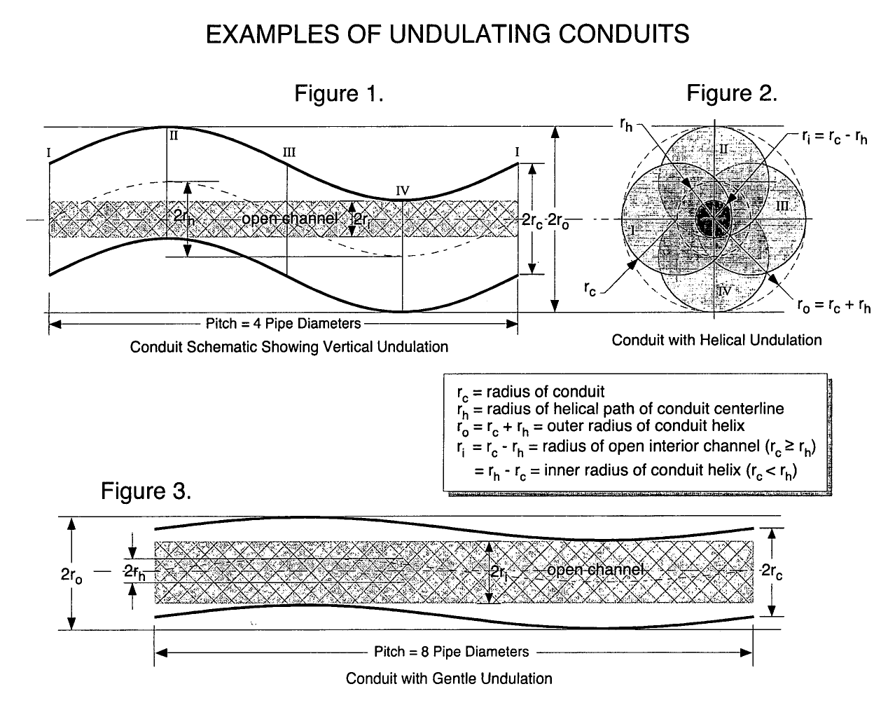

Referring to FIGS. 1 and 2, conjointly, the undulating conduit hydrodynamic mixer is a static mixing apparatus of a preselected and predetermined length of elongated tubular conduit. It allows for mixing and transporting various substances including highly abrasive solids-containing slurries. As further discussed herein, the conduit member can be interconnected into a transportation and processing separation system.

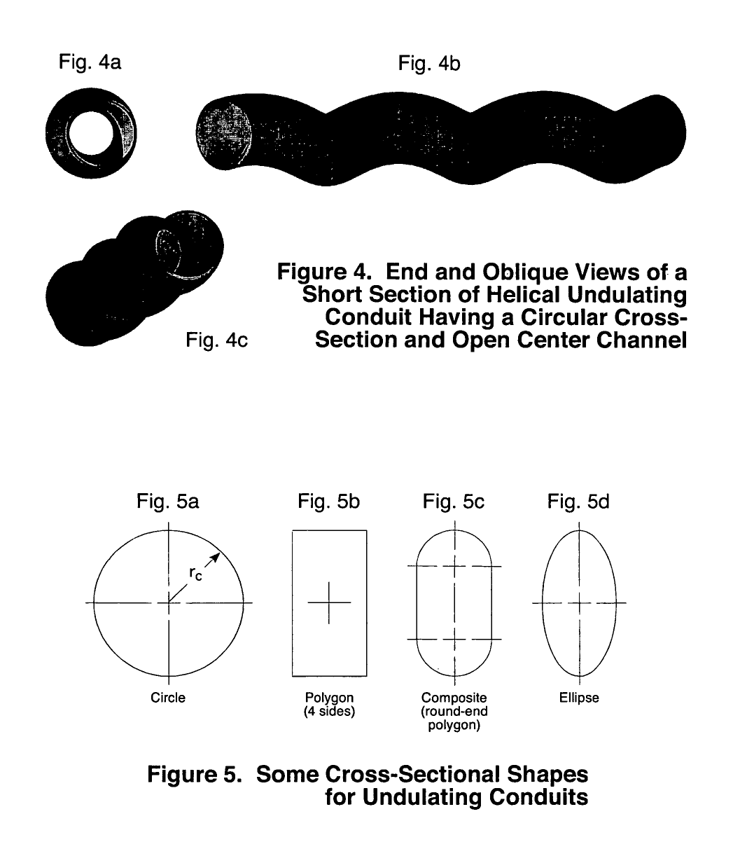

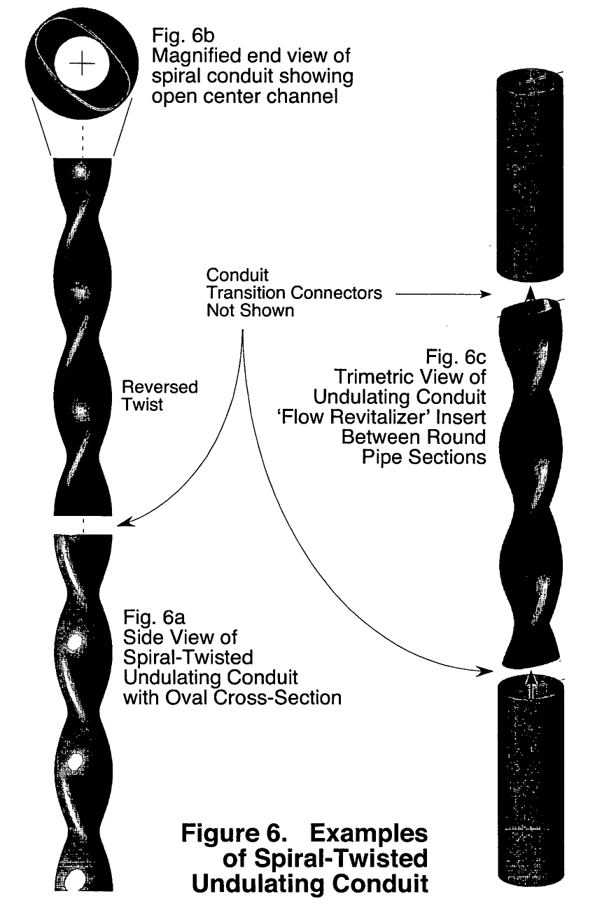

In accordance with the present invention, the undulations may take a variety of serpentine paths or shapes with various pitches (FIG. 3), repetitive or varying waves and differing cross sections, FIGS. 4, 4a, 5, 6. The undulations can be of a helical type formation (i.e., coil spring configuration) such as could be advantageously used for round pipe cross-sections, or a spiraled screw type shape for pipes of oval, polygonal, or other geometric cross-sections or combinations thereof, or the undulations can be sinusoidal when the conduit is not free to undulate in three dimensions.

It is not necessary that the conduit walls be of uniform thickness. For example, the exterior surface of the conduit could have a cylindrical pipe shape, while the interior surface of the conduit could have an undulating shape, thereby forming an undulating passage inside an externally cylindrical pipe of varying wall thickness. Such a design is particularly appropriate for small diameter undulating conduits or for relatively short ‘revitalizer’ sections of undulating conduit. It will be appreciated that the use of other than round conduit, or other than a mathematically precise helix for the path of undulation, is also permissible as well without deviating from the intent of this invention.

Helical type undulations are defined by geometry, having parameters such as conduit radius, radius and pitch of the helical path of the conduit centerline, the offset between the centerline of the conduit cross-section and the centerline of the helical path, and the inner and outer radii of the resulting conduit undulations.

Spiraled screw-shaped undulations are a special case of helical undulation in which the radius of the helical path undulation is zero but the pitch of undulation is non-zero. Spiraled screw undulations can be defined by parameters such as the spiral screw pitch, the offset between the conduit cross-section centerline and the centerline of the spiral path, and the cross-sectional shape of the conduit, for instance, oval, elliptical, semicircular, polygonal, or a combination thereof, or other non-circular shape.

Alternatively, undulations can be formed by indenting the outside of a conduit in a spiraled screw type manner. The indentations can be grouped and placed at predetermined intervals. In a preferred embodiment appropriate for conduits containing slurried solids, the indentations are limited to the upper portion of the conduit only and do not extend around the full circumference. Upper-surface indentations leave a straight conduit bottom that offers less resistance to sliding solids, is less prone to wear, and has no pockets to capture settled solids and impede resuspension during startup after a shutdown. During restart, the upper-surface undulations create currents angled down toward the conduit bottom, which disturb the settled solids and revitalize the flow.

Resuspension of Settled Solids.—In yet another preferred embodiment of the Undulating Conduit Hydrodynamic Mixer, it is particularly advantageous for the conduit to follow a helical path whose radius rₕ is less than the conduit hydraulic radius r_{c}. This configuration provides an open inner channel of radius rᵢ=r_{c}−rₕ along the longitudinal axis of the undulating conduit, through which it is possible for fluid to flow in a straight line without undulation. With this configuration, even if the lower undulations of the conduit are almost completely plugged with settled solids after an unplanned shutdown, this center channel allows fluid to be pumped through the unplugged upper undulations of the conduit. The flow follows the conduit's upper undulations and develops primary and secondary motions that aid resuspension of settled solids in the conduit's lower undulations, thereby returning the entire conduit to the fluidized flow condition.

Premature Separation/Stratification.—The transportation of slurries of various compositions particularly in large diameter straight pipes (10″+) tends to give rise to premature separation and/or stratification of elements.

By choosing appropriate geometry parameters, the undulating conduit hydrodynamic mixer lends itself to precise control and therefore management of the flow, while the alternating primary and secondary flow patterns create a mixing effect which prevents premature separation and stratification of fluid components transported within the pipeline.

Flow Velocity. The swirling action in the undulating conduit hydrodynamic mixer keeps solids in constant suspension, which means that deposition of solids along the base of the pipe is considerably less than in a straight pipe; ergo, lower velocities of slurry travel are feasible without causing deposition. The lower velocity significantly reduces the abrasive effect of the solids.

Slurry Conditioning. The entry of screened slurry into the undulating conduit hydrodynamic mixer, brings with it lumps of oil sand reduced in size for additional digestion.

The swirling flow pattern in the undulating conduit hydrodynamic mixer is conducive to better abrading and digestion of lumps.

The “folding-over” mixing action of the undulating conduit hydrodynamic mixer enhances the contact and attachment of air to the oil droplets thus enhancing the conditioning of the slurry.

Economy of Development of the Invention Prototype. Since the undulating conduit hydrodynamic mixer system is based on principles of hydraulic flow, most of its parameters can be established theoretically and a numerical model developed and proven experimentally within a relatively short time and at a reasonable cost.

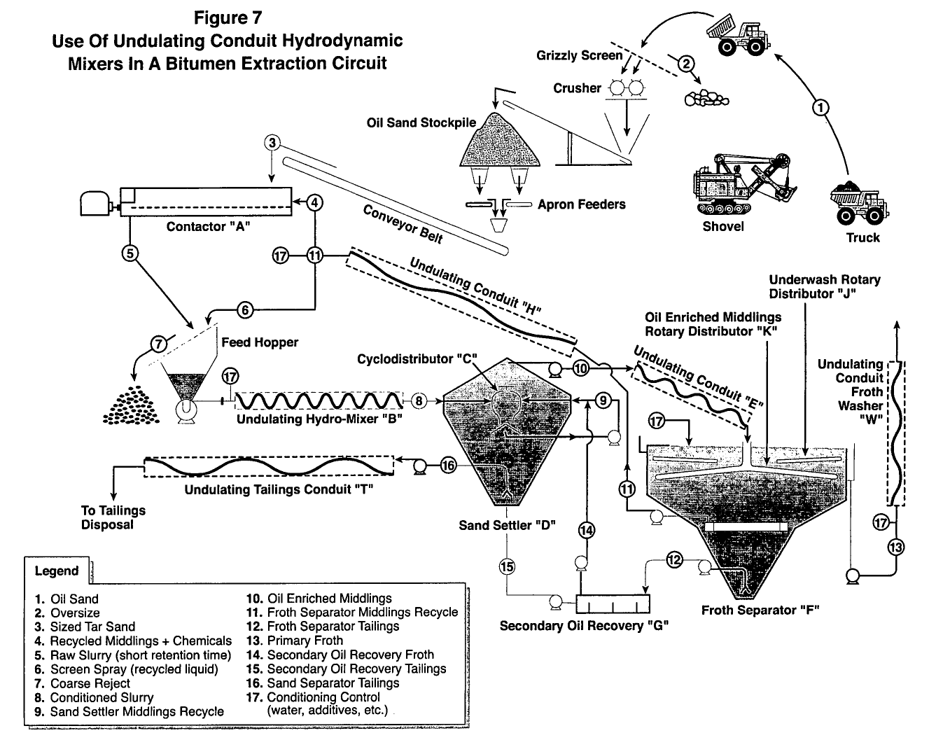

The Undulating Conduit Hydrodynamic Mixer Can Be Utilized in Several Phases of Mixing, Transport and Separation. The undulating conduit hydrodynamic mixer lends itself to use in at least three stages of mixing, transport and extraction, as illustrated in FIG. 7. A description of the oil sand extraction process shown in this Figure is provided in the following sections.

Stage #1—Undulating conduit hydrodynamic mixer (B) inserted as a hydrodynamic mixer between contactor (A) and sand settler (D). The oil sand slurry is preconditioned in the contactor (A) as dense media. Contactor (A) is shown as a pug mill in FIG. 7. However, this function could also be provided by an undulating conduit hydrodynamic mixer.

After one or two minutes of mixing, the slurry is diluted and pumped through the undulating conduit hydrodynamic mixer (B) where it is further conditioned before entering the sand settler (D) and cyclo distributor (C). The diluted dense media slurry stream (8) will have a typical weight composition of approximately 65% solids, 10% bitumen and the remainder water. The components of the diluted dense media must stay in suspension between (A) and (D) to prevent conglomerates forming from the solids, bitumen and fines. The swirling flow of the undulating conduit hydrodynamic mixer keeps these components in suspension until the slurry reaches the flotation stage. This also prevents rapid conduit wear that would otherwise be caused by settled solids sliding between (A) and (D).

In Stage #2, the introduction of the undulating conduit hydrodynamic mixer (E) in transportation of the oil-laden middlings from the sand settler (D) to the froth separator (F) prevents premature coalescence of aerated oil globules and solids. The undulating conduit hydrodynamic mixer maintains the contents as a well-mixed suspension so that they can be evenly distributed across the Froth Separator area to yield optimum product.

In stage #3, the undulating conduit hydrodynamic mixer (H) will transfer middlings from the froth separator (F) to the contactor (A), to be used as a slurry dilution stream. The function of the undulating conduit hydrodynamic mixer between (F) and (A) is to maintain a homogeneous fluid suspension and thereby prevent formation of viscous amalgams that could restrict the flow. The working of this system enhances oil recovery by bringing the unaerated oil droplets back into the system, and also recycles fines that enhance transport of the slurry.

In stage #4, the undulating conduit hydrodynamic mixer (T) will transfer tailings from the sand separator (D) to the tailings disposal area. The tailings stream (16) will have a typical weight composition of approximately 65% coarse and fine solids, less than 2% bitumen and the remainder water. The function of the undulating hydrodynamic mixing conduit (T) is to maintain a well-fluidized tailings slurry that can be pumped at high density without causing rapid localized abrasive wear due to settled solids sliding along the conduit bottom. The undulating hydrodynamic mixing conduit will also be resistant to plugging with settled solids during a tailings line shutdown.

Mobility of the Undulating Conduit Hydrodynamic Mixer. The undulating conduit hydrodynamic mixer can be structured to be compact and mobile, so that it can be moved about in the mining sites if necessary.

Cost Effectiveness. The undulating conduit hydrodynamic mixer can displace some of the mixing equipment which is in current use at a considerably lower capital cost, lower operational and maintenance cost, and reduced down time to repair and/or replace worn out equipment.

The Process Described in the Application of this Invention. Oil sands contain sharp, various sized grains of sand particles, bitumen (a high viscosity oil) and connate water containing various amounts of corrosive chlorides. Conditioning starts in contactor (A) with the addition of fresh water, middlings from froth separator and chemicals if required.

The next step in preparation of slurry is accomplished in the hydrodynamic mixer, where it will be gently conditioned by thoroughly mixing while air, chemicals, predetermined energy and set time will be applied.

The next function is accomplished in the sand settler (D). Here, the slurry is diluted, mixed with recycled middlings in the cyclodistributor (C) followed by settling of the sand and floating of oil and middlings.

Settled sand, diluted by tailings from secondary oil recovery is removed for disposal while oil and floating middlings are transported by undulating conduit hydrodynamic mixer, to prevent coalescence of aerated oil droplets with high solids middlings, to the Froth Separator (“F”). In this stage of process, oil is floated off and removed as final froth while middlings containing liquid, some oil and fines (solid particles usually less than 44 microns), are recycled to the Contactor.

Static Undulating Conduit Hydrodynamic Mixer Management of Settling and Flotation Problems. The transport of slurry in straight pipes is subject to the problem of blockage caused by solids. At times of reduced velocities and/or stoppage, heterogeneous slurries, such as oil sand slurry, settle rapidly to form a sandy or hard deposit.

Similarly, in particular when processing high oil content ore (+12%), the spontaneous rise of aerated oil droplets forms a viscous amalgam at the top of the conduit, which increases in size with time of travel, building up system pressure and restricting the flow of slurry.

Solids suspended in the aerated viscous amalgam layer also cause high conduit wear where this layer slides along the conduit walls. The viscous amalgam layer is dispersed, or is prevented from forming, by the low-shear mixing action of slurry flow within the undulating conduit hydrodynamic mixer.

The undulating conduit hydrodynamic mixer will overcome the above deteriorating conditions, even at the low fluid velocities of laminar flow, by keeping the slurry in a state of gentle swirling flow. The slurry is subjected to continuous flow direction changes, vortexing and rotation, and as a result the elements are kept in motion.

Undulating Conduit Hydrodynamic Mixer Management of Abrasion Problem. By keeping solids in suspension the abrasive aspect of moving sand will be reduced. The velocity can be reduced without loss of mixing benefit; the sands are evenly distributed within the slurry, which also minimizes the abrasive effect on the walls of the conduit. With the sands in continuous suspension there is no settlement to the bottom of the conduit to create uneven wear on its base. In other words, the total wear factor is both reduced and spread out evenly within the pipe.

Applications. This invention offers a great range of potential applications. It is a mixer and can also serve as a materials transporter that incorporates a controlled mixing function.

Some uses are oil extraction from Alberta oil sands (water wet sand grains); U.S. oil sands (oil coated sand grains); and oil sands deposits in other parts of the world.

Various utilities such as water treatment plants and sewage treatment plants.

Industrial uses such as petrochemical industries, various solids transport industries such as transport of potash ore, coal and other mined minerals, dredging of harbors and rivers, paint manufacturing, and the food preparation industry. It can enhance and improve existing systems by the principle of the undulating conduit apparatus.

One particular use to which this invention is suited is in the extraction of oil from Fort McMurray oil sands deposits in the vicinity of the Athabasca River in northeastern Alberta, Canada. Because of the smaller size of the apparatus, its low capital cost, lower operating expenses and portability, this invention has potential to allow the development of marginal oil sands deposits by small-scale operators.

This capability may be of benefit to less prosperous countries and smaller regional economies that have oil sands deposits.

Explanation of Flow Diagram (FIG. 7) Showing Utilization of Static Undulating Conduit Hydrodynamic Mixer in the Proposed Oil Extraction Process.

FIG. 7 is an example flow sheet for a method of separating oil from oil

Contactor (A). The contactor is a sturdy mixing device for preconditioning of the oil sand slurry. The Contactor accomplishes oil sand lump digestion efficiently with a minimum of emulsification of the bitumen. A Pug Mill contactor can perform the required oil sand lump digestion and slurry preconditioning, or alternatively an Undulating Conduit Hydrodynamic Mixing contactor can be used for this purpose.

The contactor can be mounted and operated on mobile trailers, thus increasing mining flexibility. Retention time at this stage should preferably be short (a minute or two) while holding slurry consistency around 25% liquid by weight (including connate water).

The temperature of slurry at this stage, should be maintained around 30-55° C., to enhance diminution of tar sand lumps, thus liberating bitumen matrix intact.

To control the density of the above slurry, a stream (4) containing recycled middlings from the froth separator (F), chemicals and possibly fresh water is added.

After mixing is completed, this slurry (5) overflows the lip of the contactor and then falls through the screen into the pump hopper.

Fresh hot water (6) or a recycle stream (11) can be applied to dilute and propel this slurry through the screen openings, as well as to wash attached oil off the rejected oversize lumps (7).

The size of rejects (7) is dictated by the handling capability of the down-stream equipment, in this case, the diameter of Undulating Conduit Hydrodynamic Mixer (B). During cold winter months, rejects containing frozen lumps of undigested oil sand might be recycled back to the Contactor (A).

Process Additives. The final adjustment of slurry density, the slurry pH, as well as addition of dissolved air, can be made via stream (17), before it enters the Undulating Conduit Hydrodynamic Mixer. Using the undulating conduit (in contrast to a straight pipe), the addition of dissolved air could be tolerated without increasing the flow stratification and possible pipe wear by aerated viscous amalgam.

The screened preconditioned slurry with additives (17) is pumped through the Undulating Conduit Hydrodynamic Mixer. For effective mixing, one to two minutes of retention time should be adequate.

Static Hydrodynamic Mixer Undulating Conduit. The static hydrodynamic mixer undulating conduit can be used in various configurations to fulfill different functions. In FIG. 7, five static hydrodynamic mixer undulating conduits are utilized (shown as B, E, H, T and W). The hydrodynamic mixer can be utilized firstly as a pure mixer to blend fluid components together. Secondly, it can be utilized as a transporter mixer to simultaneously mix and transport the conduit contents. Thirdly, it can serve as inserts in a transportation pipe system to revitalize the contents in transit.

The static hydrodynamic mixer undulating conduit can be used as a mixer only, by applying a small length of conduit having undulations of a short pitch configuration. This static hydrodynamic mixer undulating conduit unit could be mounted on mobile equipment and operated close to the mining area.

The static hydrodynamic mixer undulating conduit could also consist of a combined mixing and transport system having continuous long-pitch undulations or a combination of straight pipes with insertions of undulating pipes. The correct design of this unit, establishing length and diameter of conduit, and diameter and pitch of the undulation, could positively influence the product quality and reduce related expenses.

Sand Settler (D). Sand accounts for around 80% of the oil sand weight. As much sand as possible should be removed from the slurry as early as possible to avoid abrasive wear on downstream equipment. The sand settler should therefore be installed as near as possible to the mine to reduce the need to transport large volumes of solids out of the mine area.

Conditioned slurry (8) is introduced into the sand settler (D) by means of the cyclodistributor (C). Here it is dispersed and diluted by recycled middlings stream (9), which also induces additional rotational momentum. The resulting motion enhances turbulence within the middlings in the lower section of the vessel, thus preventing the formation of gels (pseudo-plastic behavior).

The cyclonic action within the cyclodistributor enhances the separation of sand and aerated oil droplets by means of turbulence and density differential.

After exiting the cyclodistributor, rising aerated oil droplets and some middlings are floated to the top of the vessel and then leave the sand separator by means of a stream (10) which passes through an Undulating Conduit Hydrodynamic Mixer (E) functioning as a transporter/mixer that prevents conglomeration and stratification of aerated oil droplets.

The sand-laden portion of the slurry is discharged onto the conical deflector where it fans and spreads out. This allows any oil carried by the outflowing stream to escape. The released oil rises to the top, while the descending sand is uniformly distributed across the lower portion of the sand settler.

As the sand slides down the walls and settles towards the bottom of the settler, it densifies and releases middlings fluid and bitumen. The build-up of densified sand on the bottom creates a sand-middlings interface that acts as a seal to exclude oil-bearing middlings from the tailings stream (16).

The flux of released middlings and bitumen creates an upward flow current towards the cone under the cyclone distributor, where the released middlings and bitumen join stream (9).

The density of tailings stream (16) drawn from the bottom of the vessel, is controlled by injection of secondary oil recovery tailings (15).

Froth Separator (F). Oil-enriched middlings stream (10) is transported from the sand settler to the froth separator by means of the Undulating Conduit Hydrodynamic Mixer, which prevents coagulation of aerated oil droplets. The stream enters the froth separator via the rotary distributor (K) and is laid down uniformly across the vessel.

Streams exiting the rotating distributor (K) are mixed with surrounding liquid and, thus diluted, are the first step of the actual process of separation.

The released aerated oil globules rise to the top of the vessel, where they form a bituminous froth (13), while coarse and fine sand particles, and some unaerated bitumen, settle to the bottom of the froth separator.

Underwash. Fresh (pretreated) underwash water is introduced preferably by way of underwash rotary distributor (J) beneath the froth layer, but above the oil enriched middlings distributor (K). In this way, a highly diluted zone is provided, through which the ascending bitumen passes immediately before joining the froth. This step contributes to formation of higher froth quality by washing rising aerated bitumen droplets and maintaining a mild downward current that depresses the fines to the middlings withdrawal pipe (11). There is usually more underwash water than middlings water in the froth product, suggesting that only excess underwash water is involved in the downward flow. The dilute underwash zone leads not only to clean froth, but also maintains stable operation even when high fines oil sands are being processed.

Primary Froth. Rising to the surface, aerated oil globules form a froth (13), on average containing 60-70% oil, 6-10% solids and 20-30% water, which overflows into launders and is pumped to froth treatment facilities. An Undulating Conduit Hydrodynamic Mixer (W) may be a suitable apparatus for washing the froth. Froth washing gently shears and stretches conglomerated droplets of aerated bitumen that have trapped solids and water in the interstices between the clumped droplets. The gentle low-shear scrubbing action of fluid motion inside the undulating conduit (W) liberates the trapped solids and water in the froth without creating an emulsion.

Middlings Recycle. The middlings for recycle to the contactor (11) are taken from the froth separator via a collector pipe. By this means a certain percentage of solids (mostly as fines) are removed from the center of the froth separator (F). The withdrawal of stream (11) creates gentle shear within the center zone of the froth separator, which helps prevent the remaining fines from coalescing or gelling. Stream (11) should be transferred to the contactor (A) via Undulating Conduit Hydrodynamic Mixer to prevent formation of viscous amalgams that could restrict the flow.

Secondary Oil Recovery. Froth separator tailings (12) are withdrawn and introduced into the secondary oil recovery system (G).

Secondary Oil Recovery Froth. The product of secondary oil recovery system (14), a froth high in solids, which is introduced into middlings recycle stream (9) and forwarded to the cyclodistributor.

Secondary Oil Recovery Tailings. A low oil content discharge stream (15) from the secondary oil recovery circuit enters the sand settler (D) as a sand tailings dilution and fluidizing stream.

Sand Separator (D) Tailings. A high-solids, low oil content discharge stream (16) leaves the Sand Settler (D) and is pumped to the Sand Tailings disposal area via an Undulating Hydrodynamic Mixing Conduit (T). The function of this undulating mixer conduit is to maintain a well-fluidized tailings slurry that can be efficiently pumped at high density without excessive wear of the conduit due to sliding stratified solids. The undulating conduit is also resistant to plugging with settled solids during a tailings line shutdown.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e, meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any nonclaimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The invention comprises all the embodiments, modifications and variations coming within the scope and spirit of the claims herein.

What is claimed is:

1. A hydrodynamic static mixing apparatus comprising a preselected and predetermined configuration and length of undulating tubular conduit for mixing and/or transporting various substances, including fluids and solids contained in slurries, and said conduit being adapted to be incorporated into systems that perform one or more of the functions of fluid or slurry transport, processing and separation.

2. A hydrodynamic static mixing apparatus as claimed in claim 1 wherein said undulating conduit has a generally helical undulation.

3. A hydrodynamic static mixing apparatus as claimed in claim 1 wherein said undulating conduit has a generally sinusoidal undulation.

4. A hydrodynamic static mixing apparatus as claimed in claims 2 or 3 wherein said undulating conduit has an internally geometric cross-section.

5. A hydrodynamic static mixing apparatus as claimed in claims 2 or 3 wherein said undulating conduit has a generally round internal cross-section.

6. A hydrodynamic static mixing apparatus as claimed in claim 1 wherein the amplitude of said undulation is less than the hydraulic diameter of said conduit.

7. A hydrodynamic static mixing apparatus as claimed in claim 1 wherein the amplitude of said undulation is greater than or equal to the hydraulic diameter of said conduit.

8. A hydrodynamic static mixing apparatus as claimed in claim 1 wherein said undulating conduit has a generally helical undulation of non-zero helical pitch and zero helical radius.

9. A hydrodynamic static mixing apparatus as claimed in claim 8 wherein said undulating conduit has an internally geometric cross-section.

10. A hydrodynamic static mixing apparatus as claimed in claim 8 wherein said undulating conduit has an internally oval cross section.

11. A hydrodynamic static mixing apparatus as claimed in claim 8 wherein said undulating conduit has an internally polygonal cross section.

12. A hydrodynamic static mixing apparatus as claimed in claim 1 wherein said undulating conduit has undulations along its top portion forming the undulating interior.

13. A hydrodynamic static mixing apparatus as claimed in claim 1 wherein said conduit is curved and generally round in cross section.

14. A hydrodynamic static mixing apparatus as claimed in claim 1 wherein said conduit is interposed at various stages of either separate, or simultaneous, transportation, processing and separation of oil-laden fluids in an oil sands bitumen extraction system.

15. A hydrodynamic static mixing apparatus as claimed in claim 1 wherein said conduit has an interior undulating structure at the upper portions thereof, which provide a serpentine path that causes dynamic mixing of its flowing contents due to primary and secondary flow patterns.

16. A method of static mixing of flowing fluids comprising the steps of providing a preselected and predetermined length of undulating interior elongated tubular conduit, connecting said conduit to a conduit of a system providing one or more of the steps of fluid transportation, processing or separation, and pumping fluidized material through said undulating interior elongated tubular conduit at some stage of fluid passage through said system.

17. A method as claimed in claim 16 wherein said stage is an initial mixing stage for conditioning a slurry.

18. A method as claimed in claim 16 wherein said stage is in transportation of a slurry to keep the contents in suspension.

19. A method as claimed in claim 16 wherein said stage is in a transportation pipeline system to revitalize the contents.

20. A method as claimed in claim 16 wherein said stage is in a froth piping system to wash the froth.

21. A method as claimed in claim 16 wherein said undulating interior elongated tubular conduit is interposed at various stages of passage of oil-laden fluids through an oil sands bitumen extraction system.
